(19) United States
(12) Patent Application Publication
(10) Pub. No.: US 2026/0364505 A1
(43) Pub. Date: Nov. 19, 2026

(54) BIDIRECTIONAL MASS FLUID TRANSPORT DEVICE WITH SURFACE TOPOLOGY

(71) Applicant: W.L. Gore & Associates, Inc., Newark, DE (US)

(72) Inventors: Ryan C. Kenaley, Landenberg, PA (US); Uwe Beuscher, Landenberg, PA (US)

(21) Appl. No.: 19/142,893

(22) PCT Filed: Dec. 26, 2023
(86) PCT No.: PCT/US2023/085925

§ 371 Date: Jun. 24, 2025

Related U.S. Application Data
(60) Provisional application No. 63/435,392, filed on Dec. 27, 2022.
(60) Provisional application No. 63/490,879, filed on Mar. 17, 2023.

(51) Int. Cl. B01D 46/00; B01D 39/20; B01D 46/52

(52) U.S. Cl. CPC B01D 46/0036; B01D 39/2068; B01D 46/0001; B01D 46/52; B01D 2253/25; B01D 2257/302; B01D 2257/602

(57) ABSTRACT

Pollution control systems, articles, and methods having a surface topology for bidirectional fluid transport. The pollution control system includes at least one article comprising a surface characteristics with at least three critical portions or critical points of the surface topology. The surface topology can include channels along a first direction, wherein the channels are configured to direct fluid flow substantially along a particular direction.

### CROSS-REFERENCE TO RELATED APPLICATION

This application is a national phase application of PCT Application No. PCT/US2023/085925, internationally filed on Dec. 26, 2023, which claims the benefit of Provisional Application No. 63/490,879, filed Mar. 17, 2023, and also claims the benefit of Provisional Application No. 63/435,392, filed Dec. 27, 2022, which are incorporated herein by reference in their entireties for all purposes.

### FIELD

The present disclosure relates to the field of pollution control systems and methods for removing compounds and fine particulate matters from gas streams.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO2), mercury (Hg) vapor, and particulate matters (PM). Thus, there is a need for improvements to control systems and methods for removing sulfur oxides, mercury vapor, and fine particulate matters from industrial flue gases, such as coal-fired power plant flue gas.

### SUMMARY

Following summary is a high-level overview of various aspects and introduces some of the concepts that are further described in the Detailed Description section below. This summary is not to be used in isolation to determine the scope of the claimed subject matter. The subject matter should be understood by reference to appropriate portions of the entire specification, any or all drawings, and each claim.

In some embodiments, an article comprises a two dimensional array configuration with a three dimensional surface topology. The article includes a first two dimensional sheet having an upper and lower surface, wherein the first sheet has a three dimensional surface topology, wherein the surface topology of both the upper and lower surface comprises a two dimensional array of regular surface undulations, each undulation having a first set of at least three critical portions. The undulations adding the third dimensionality to the two dimensional array. In some embodiments, each of the at least three critical portions is one of (a) a minimum, (b) a saddle, or (c) a maximum.

In some embodiments, the surface topology includes channels along a first direction, wherein the channels are configured to direct fluid flow substantially along a first direction.

In some embodiments of the article, the first sheet comprises a filter material; a heat exchange surface; an active material; a reactive material; or a combination thereof.

In some embodiments of the article, the channels may be substantially linear along the first direction.

In some embodiments of the article, the surface topology is configured such that the fluid flow may be substantially uniform flow.

In some embodiments of the article, the channels are configured such that the fluid flow may be substantially uniform flow.

In some embodiments of the article, the minimum, the saddle, and the maximum portions are along a second direction, wherein the second direction is different from the first direction.

In some embodiments of the article, the article is configured such that the fluid flow along the second direction may be substantially non-uniform flow.

In some embodiments of the article, at least one of the each of the three critical portions is a critical point.

In some embodiments of the article, the surface topology further comprises straight edges connecting at least two of the at least three critical portions.

In some embodiments of the article, the surface topology further comprises curved portions connecting at least two of the at least three critical portions.

In some embodiments of the article, the surface topology comprises a geometric wave cross section.

In some embodiments of the article, the geometric wave cross section comprises a sinusoidal wave cross section; a non-sinusoidal periodic wave cross section; a triangular wave cross section; a rectangular wave cross section; a square wave cross section; or a combination thereof.

In some embodiments of the article, the filter material comprises a sorbent polymer composite material.

In some embodiments of the article, the sorbent polymer composite material comprises a sorbent material; and a polymer material.

In some embodiments of the article, the sorbent material comprises at least one of an activated carbon, a silica gel, a zeolite, or a combination thereof.

In some embodiments of the article, the polymer material comprises at least one of polytetrafluoroethylene; polyfluoroethylene propylene; polyperfluoroacrylate; polyvinyllidene fluoride; a terpolymer of tetrafluoroethylene; hexafluoropropylene-vinylidene-fluoride, polychlorotrifluoroethylene, or a combination thereof.

In some embodiments, the article comprises a second sheet coupled to at least a portion of the first sheet.

In some embodiments of the article, the second sheet has a second surface topology comprising at least a flat portion.

In some embodiments, a second sheet which includes a two dimensional array configuration with a three dimensional surface topology. The second sheet adds a second two dimensional sheet having an upper and lower surface, wherein the second sheet has a three dimensional surface topology, wherein the surface topology of both the upper and lower surface comprises a two dimensional array of regular surface undulations, each undulation having a second set of at least three critical portions. The undulations adding the third dimensionality to the two dimensional array. Accordingly, in some embodiments, the second sheet is also a two dimensional sheet having an upper and lower surface, wherein the second sheet has a three dimensional surface topology of both the upper and lower surfaces of the second sheet comprises a two dimensional array with a third dimensional surface topology with undulations having crests and troughs, each undulation having a first set of at least three critical portions. In some embodiments, each of the at least three critical portions of the second sheet surface topology includes (a) a minimum, (b) a saddle, and (c) a maximum. In some embodiments of the article, the second sheet includes a second filter material, a heat exchange surface; an active material; a reactive material; or a combination thereof.

In some embodiments of the article, at least one of the at least three critical portions of the first sheet is coupled to the second sheet.

In some embodiments of the article, the first sheet is coupled to the second sheet by an adhesive, an ultrasonic weld, a thermal weld, a laser weld, or a combination thereof.

In some embodiments of the article, the first sheet is coupled to the second sheet by an adhesive.

In some embodiments, the article further comprises a module frame, wherein the first sheet and the second sheet are connected to the module frame.

In some embodiments, a module comprises a plurality of sheets, wherein each of the plurality of sheets has a surface topology comprising at least three critical portions, wherein each of the at least three critical portions is (a) a minimum, (b) a saddle, or (c) a maximum.

In some embodiments of the module, each of the plurality of sheets comprises a filter material, a heat exchange surface; an active material; a reactive material; or a combination thereof.

In some embodiments of the module, the filter material comprises a sorbent polymer composite material.

In some embodiments of the module, the sorbent polymer composite material comprises a sorbent material; and a polymer material.

In some embodiments, a method of producing an article according to those disclosed herein comprises obtaining a sheet; rolling the sheet over a roller having a roller mold; and forming a surface topology on the sheet, wherein the surface topology comprises at least three critical portions, wherein each of the at least three critical portions is (a) a minimum, (b) a saddle, or (c) a maximum.

In some embodiments of the method, the method includes adding to the sheet a filter material; a heat exchange surface; an active material; a reactive material; or a combination thereof.

In some embodiments, the method further comprising obtaining a second sheet; rolling the second sheet over the roller having the roller mold; and forming a second surface topology on the second sheet, wherein the second surface topology comprises at least three critical portions, wherein each of the at least three critical portions is one of (a) a second minimum, (b) a second saddle, or (c) a second maximum; and the method includes bonding together at least a portion of the sheet and at least a portion of the second sheet.

In some embodiments of the method, the portion of the sheet includes one of the at least three critical portions of the sheet.

In some embodiments of the method, the portion of the second sheet includes one of the at least three critical portions of the second sheet.

In some embodiments of the method, the portion of the second sheet includes one of the at least three critical portions of the second sheet.

### BRIEF DESCRIPTION OF DRAWINGS

References are made to the accompanying drawings that form a part of this disclosure and that illustrate embodiments in which the systems and methods described in this Specification can be practiced.

FIG. 1A is a schematic perspective top view of a surface topology according to an embodiment.

FIG. 1B is a schematic side view of the surface topology shown in FIG. 1A.

FIG. 1C is another schematic side view of the surface topology shown in FIG. 1A.

FIG. 2 is another schematic perspective top view of a surface topology according to an embodiment.

FIG. 3 is a schematic side view of several sheets bonded together.

FIG. 4 is a schematic perspective top view of a surface topology according to an embodiment.

FIG. 5 is a schematic perspective top view of a surface topology according to an embodiment.

FIG. 6 is a schematic perspective top view of a surface topology according to an embodiment.

FIG. 7 is a schematic perspective top view of a surface topology according to an embodiment.

FIG. 8 is a schematic diagram for a method of manufacturing an embodiment of one or more article(s) described herein.

FIG. 9 depicts a non-limiting embodiment of a pollution control system having any of the article(s) described herein.

Like reference numbers represent the same or similar parts throughout.

### DETAILED DESCRIPTION OF DRAWINGS

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be: disposed directly between both of the two other structural elements such that the particular structural component is in direct contact with both of the two other structural elements; disposed directly next to only one of the two other structural elements such that the particular structural component is in direct contact with only one of the two other structural elements; disposed indirectly next to only one of the two other structural elements such that the particular structural component is not in direct contact with only one of the two other structural elements, and there is another element which juxtaposes the particular structural component and the one of the two other structural elements; disposed indirectly between both of the two other structural elements such that the particular structural component is not in direct contact with both of the two other structural elements, and other features can be disposed therebetween; or any combination(s) thereof.

According to some embodiments, an article (e.g., device or component of a device) comprises a thin material which can be described as a sheet (or also called a sheet-like material). As a sheet it has an upper surface and a bottom surface and prior to forming it has an original center plane orientation. The sheet has a certain shape or form on its major or upper surface, and this shape can be described as a surface topology. In some embodiments, the surface topology can be a regularly repeating two dimensional array form with a three dimensional topology, wherein the third dimension includes a set of at least three critical portions. These critical portions can include critical points (if the portions are small enough to be described as being generally a point). As used herein a critical portion is a mathematical definition of a region of the surface in which the local two dimensional shape changes with respect to an original central plane orientation of the unformed sheet material. In some embodiments, each of the at least three critical portions is (a) a minimum, (b) a saddle, i.e. an inflection region where the surface slope is zero, or (c) a maximum, i.e. a peak. That is, the surface topology can include a “low portion” or a “low point” when viewed from a certain viewpoint. For example, when viewed along a particular cross-section, the sheet can have one or more spaced “minimum portions” or a “low” points. Similarly, the surface topology can include a “high portion” or a “high point” when viewed from a certain viewpoint. For example, when viewed from along a particular cross-section, the sheet can have one or more “maximum portions” or a “high” points.

As discussed below, the magnitude of these “low” or “high” portion(s) can be measured or determined mathematically as an “amplitude” parameter(s) which describes, in some embodiments, the surface topology. Further, the surface topology can include a “saddle” (also called “minmax”) which describes a portion on the surface where the slopes (i.e., derivatives) in orthogonal directions are all zero (a critical point), but which is not a local extremum of the function. An example of a saddle point (or a saddle surface portion) is when there is a critical point (or area) with a relative minimum along one axial direction (between peaks) and at a relative maximum along the crossing axis. However, a saddle need not be in this form. These configurations of the surface topology of the sheet can form channels along a particular direction of the sheet, such that the channels can direct fluid flow substantially along that direction. In some embodiments, the surface topology of the sheet can cause substantially uniform flow of fluid along a particular direction (e.g., via the channels). These channels or paths along the surface topology of the sheet are typically not straight but rather guide the fluid around adjacent features of the topology.

Further, in some embodiments, the surface topology of the sheet can cause non-uniform flow of fluid along another direction or at the edge portions of the surface topology. In some embodiments, the shapes and positions of these surface topology features can cause repeated splitting of the flowing phase, resulting in one or more of higher mixing, heat transport to heat materials, or mass transport to a reactive surface (e.g., material of the sheet can be or include a reactive material or compound which can react with the fluid flowing over, past, therethrough, or a combination thereof the sheet). In some embodiments, a gas phase flow is orthogonal to the vector of gravity. (horizontal, or azimuthal flow). The gas flow path includes surface topology such that flow is regularly disrupted (e.g., non-uniform). A second, liquid phase (generated by reaction, or trickling from the top) is present, where the liquid flow path contains lines for smooth, gravity driven drainage (e.g., substantially uniform flow). This embodiment can be very useful when the liquid product is generated from gaseous reactants within the catalytic solid phase and/or un the trickling configuration as in a gas/liquid exchanger.

According to some embodiments, the surface topology can increase or maximize a production of liquid product without increasing the pressure drop of the gaseous phase motivated across a reactive surface (i.e., catalytic surface). These embodiments can accomplish this by facilitating liquid drainage, as portions of the sheet (or areas of the surface) with high surface shear force motivated by the flowing gas phase can enhance displacement of liquid into quiescent zones for gravity driven drainage (e.g., via channels on the surface topology).

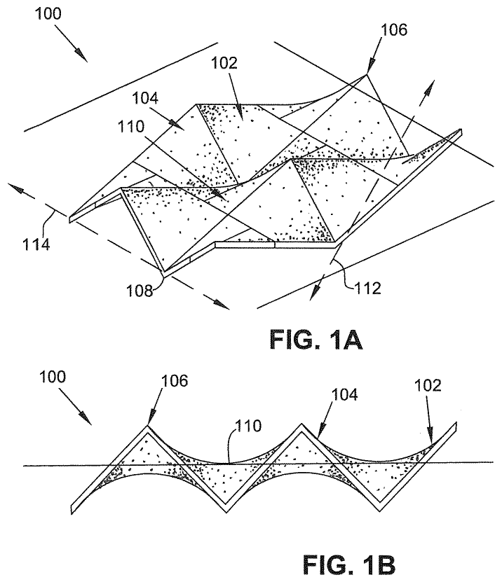

Shown in FIGS. 1A, 1B, and 1C, is an exemplary sheet 100 having a surface topology 102 according to an embodiment. The surface topology 102 is shown from a top perspective view in FIG. 1A, where various repeating pyramidal features 104 having maximum peaks 106 (e.g., maximum portions or points) can be seen. These maximum peaks 106 area also shown in FIGS. 1B and 1C. Further, the surface topology 102 includes minimum troughs 108 (e.g., minimum portions or points). The surface topology 102 includes a saddle 110 (surface or point) positioned between nearest neighbor maximum peaks 106 and minimum troughs 108. The saddle 110 is more readily visible in FIG. 1B.

FIG. 1B is a side view of sheet 100 along a first direction 112 (as shown in FIG. 1A), and the surface topology 102 along this direction 112 undulates from minimum points 108 to the saddle points 110. The transition along this direction 112 is relatively smooth, according to some embodiments. This can be described as a “channel” for flowing a fluid, and this configuration can promote substantially uniform flow of fluid along this direction 112.

FIG. 1C shows a view along a different direction 114 (as shown in FIG. 1A), where the flow path along this direction 114 encounters sharp or sharper edges according to the minimum troughs 108 and the maximum peaks 106 of the surface topology 102. These features can promote non-uniform flow of a fluid when the fluid flows along this direction 114.

Although the embodiments depicted in FIGS. 1A-1C include pyramidal features 104, other geometric configurations are possible. For example, instead of or in combination with the pyramidal features 104, embodiments of a surface topology can also include a sinusoidal wave cross section; a non-sinusoidal periodic wave cross section; a triangular wave cross section; a rectangular wave cross section; a square wave cross section; or a combination thereof.

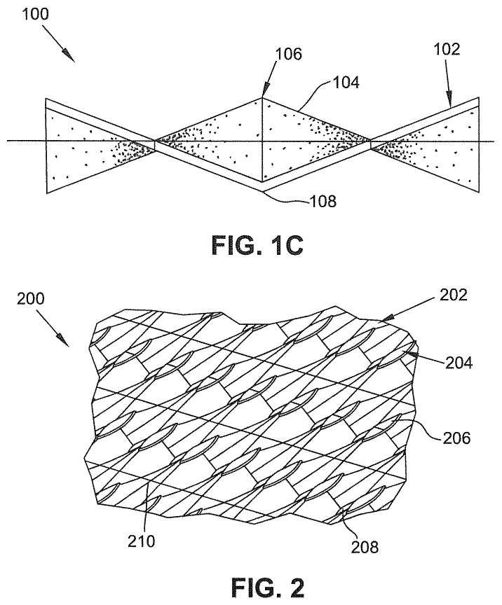

In other embodiments, the “peaks” can be flattened or truncated as shown in FIG. 2. As an example, these flattened peak regions can be used to couple to another sheet. In this embodiment of a sheet 200 with another surface topology 202, the peaks of the pyramidal features 204 are flat or truncated so as to have flattened surface portions 206. Otherwise, the sheet 200 is similar to that shown in FIGS. 1A-1C. That is, the surface topology 202 has various repeating pyramidal features 204 having flat peaks 206. The surface topology 202 includes minimum troughs 208 (e.g., minimum portions or points) that also may be flattened or truncated. The surface topology 202 includes a saddle 210 (surface or point) positioned between nearest neighbor flat peaks 206 and minimum troughs 208. The surface topology 202 along one direction undulates from minimum points 208 to the saddle points 210. The transition along this direction is relatively smooth, according to some embodiments. This can be described as a “channel” for flowing a fluid, and this configuration can promote substantially uniform flow of fluid along this direction. Along a different direction, the flow path encounters sharp or sharper edges/ridges. These features can promote non-uniform flow of a fluid when the fluid flows along this direction. The flat peaks 206 can be used to bond (e.g., connect) the sheet 200 to another sheet.

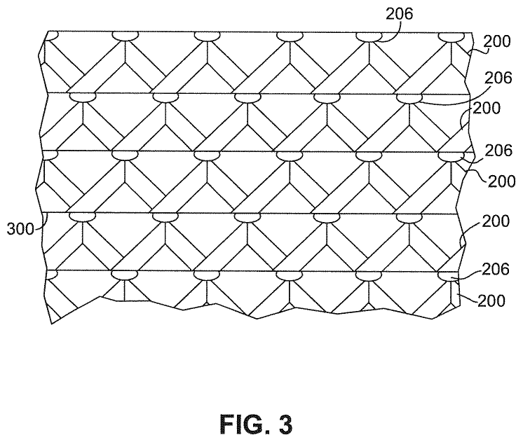

FIG. 3 is a schematic side view of several sheets bonded together. That is, where embodiments of sheets 200 similar to that shown in FIG. 2 are stacked on top of each other, the flat peaks 206 can be the connecting regions between multiple sheets. Some sheets 300 can be flat, and these flat sheets 300 can be positioned between sheets 200 with surface topology (e.g., the surface topology 202 shown in FIG. 2).

In some embodiments of the surface topology, at least some of the surface features include repeating patterns. Some of these repeating patterns can include several parameters to define the repeating patterns. The parameters can be four or more. Examples of the parameters include: amplitude, frequency, orientation, and function. Amplitude is the height or depth of the surface topology. Frequency can be determined as the inverse of the distance between peaks. Orientation can mean the two primary directions or axes that produce a surface topology, and the skew angle between the two directions or axes (the two directions does not need to be perpendicular). Function means the shape of the corrugation function (e.g., sin waves, square waves, sawtooth waves, etc.). These parameters can be varied for optimizing a differential gas flow and liquid flow with the same surface topology.

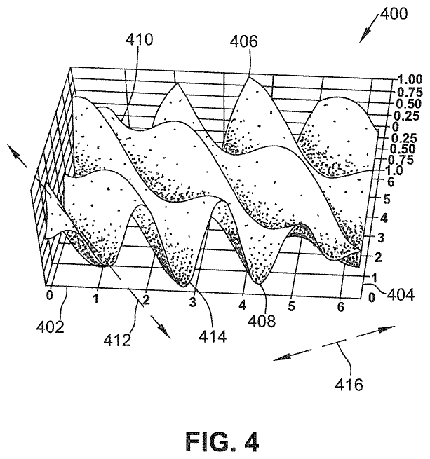

For example, FIG. 4 is a schematic perspective top view of a surface topology 400 according to an embodiment. The first axis 402 and the second axis 404 are defined here to be perpendicular to each other. However, the surface topology 400 here forms various maximums 406, minimums 408, and saddles 410. Further, along one direction 412, a channel 414 is shaped for improved substantially uniform flow. Along another direction 416, the peaks 406 and troughs 408 enhance a substantially non-uniform flow.

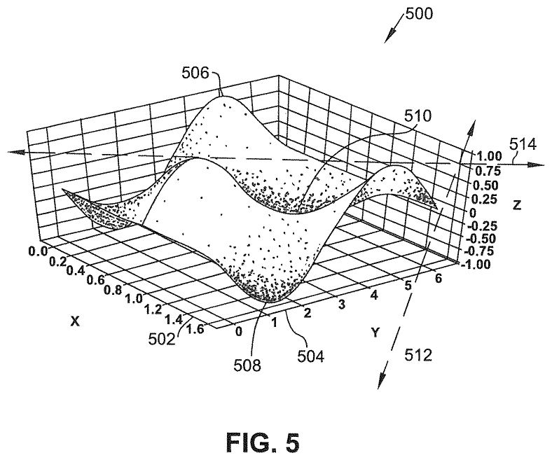

FIG. 5 is a schematic perspective top view of a surface topology 500 according to another embodiment. The first axis 502 and the second axis 504 are defined here to be perpendicular to each other. However, the surface topology 500 here forms various maximums 506, minimums 508, and saddles 510. Further, along one direction 512, the surface topology 500 has an undulating shape for improved uniform or smooth fluid flow. Along another direction 514, the peaks 506 and troughs 508 enhance a non-uniform flow.

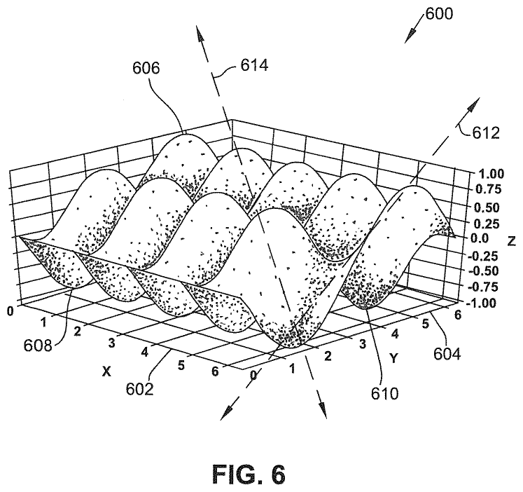

FIG. 6 is a schematic perspective top view of a surface topology 600 according to another embodiment. The first axis 602 and the second axis 604 are defined here to be perpendicular to each other. However, the surface topology 600 here forms various maximums 606, minimums 608, and saddles 610. Further, along one direction 612, the surface topology 600 has an undulating shape for improved uniform or smooth flow. Along another direction 614, the peaks 606 and troughs 608 enhance a non-uniform flow.

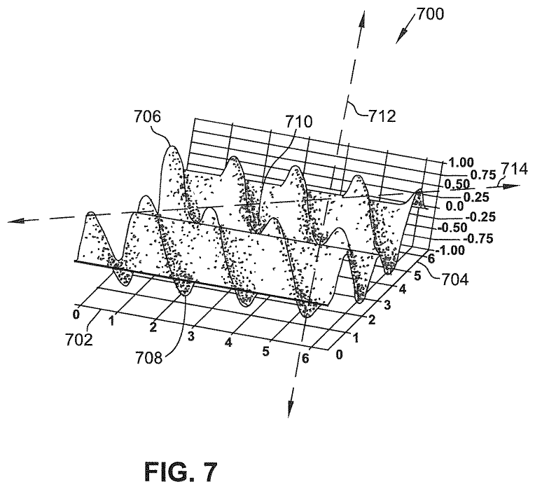

FIG. 7 is a schematic perspective top view of a surface topology 700 according to another embodiment. The first axis 702 and the second axis 704 are defined here to be perpendicular to each other. However, the surface topology 700 here forms various maximums 706, minimums 708, and saddles 710. Further, along one direction 712, the surface topology 700 has an undulating shape for improved uniform or smooth flow. Along another direction 714, the peaks 706 and troughs 708 enhance a non-uniform flow.

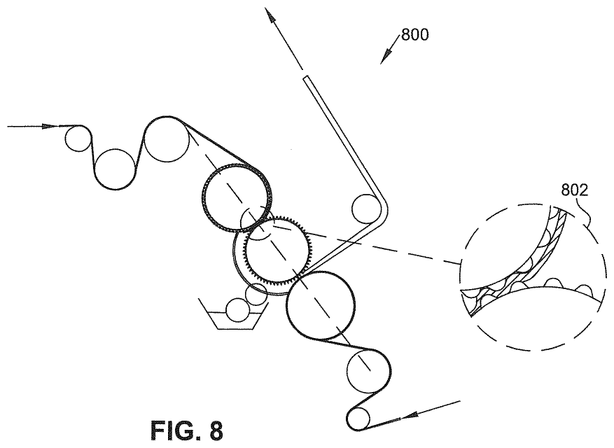

FIG. 8 is a schematic diagram for a method 800 of manufacturing an embodiment of one or more article(s) described herein. In some embodiments of method for producing the articles with surface topology described herein can be performed by obtaining a sheet, and rolling the sheet over a roller having a roller mold 802, as shown in FIG. 8, which forms the surface topology onto the sheet. Additional steps for producing multiple sheets include obtaining another sheet, and where the second sheet is flat, not forming a surface topology on the second sheet, and bonding the first sheet with the surface topology as disclosed herein to the flat second sheet. Where the second or third sheet does include surface topology, then rolling that sheet over a roller having a roller mold, as shown in FIG. 8, and bonding the sheets together. Additional steps for producing a module for a system include connecting the multiple sheets bonded together to a module frame. Each sheet can comprise a filter material; a heat exchange surface; an active material; a reactive material; or a combination thereof.

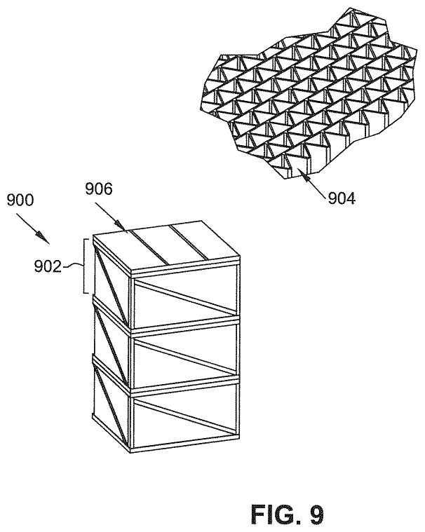

FIG. 9 depicts a non-limiting embodiment of a pollution control system 900 incorporating at least one of the article(s) described herein. Some non-limiting uses of the pollution control system 900 can be for controlling air pollutant emissions to be in compliance with various air pollutant emissions standards. The pollution control system 900 can be configured for capturing elemental and oxidized gas phase mercury from industrial flue gas. The pollution control system 900 can include discrete stackable modules 902 that can be installed downstream of a particulate collection system. In some embodiments, the modules 902 can be configured with one or more embodiments of the article(s) 904 (shown in an enlarged partial view in FIG. 9) described herein. Accordingly, in some embodiments, one or more embodiments of the article(s) 904 are connected to the module frame 906 of the module 902.

In some embodiments, the pollution control system 900 can include several articles (according to any one or more of the embodiments described herein) formed into a plurality of channels. In such embodiments, the gas stream can flow between the channels such that the gas stream is in direct contact with at least a part of a reactant material. In some embodiments, the plurality of channels of the device can facilitate the flow of reactants, such as gaseous components, over one or more surfaces of the system and facilitate the drainage of at least one liquid product. In some embodiments, the system can capture both elemental and oxidized mercury from the flue gas stream as the flue gas flows past (e.g., over or through the material). Mercury can be securely bound within material of the article via chemisorption. SO₂ can also be adsorbed and/or absorbed and catalyzed (via SO₂ oxidation catalyst) to liquid sulfuric acid, which can form droplets and expelled from the article. The droplets can flow downward via gravity on the surface of the article.

Some embodiments of the present disclosure relate to a device that includes a sorbent polymer composite material. As used herein “sorbent polymer composite material” is defined as a sorbent material embedded within a matrix of a polymer material. In some embodiments, the polymer material of the sorbent polymer composite material includes at least one of: polyfluoroethylene propylene (PFEP); polyperfluoroacrylate (PPFA); polyvinyl-lidene fluoride (PVDF); a terpolyrner of tetrafluoroethylene, hexafluoropropylene-vinylidene-fluoride (THV), or polychloro trifluoro ethylene (PCFE), or combinations thereof. In some embodiments, the polymer material includes polytetrafluoroethylene (PTFE). In some embodiments, the polymer material includes expanded polytetrafluoroethylene (ePTFE). In some embodiments, the sorbent material of the sorbent polymer composite material includes at least one of: activated carbon, coal-derived carbon, lignite-derived carbon, wood-derived carbon, coconut-derived carbon, silica gel, zeolite, or combinations thereof. In some embodiments, the sorbent polymer composite material further includes a halogen source. In some embodiments, the halogen source may be incorporated into the sorbent polymer composite material by any suitable technique which may include, but is not limited to, imbibing, impregnating, adsorbing, mixing, sprinkling, spraying, dipping, painting, coating, ion exchanging or otherwise applying the halogen source to the sorbent polymer composite material. In some embodiments, the halogen source may be located within the sorbent polymer composite material, such as within any porosity of the sorbent polymer composite material. In some embodiments, the halogen source may be provided in a solution which may, under system operation conditions, in situ contact the sorbent polymer composite material.

In some embodiments, the halogen source is chosen from at least one of sodium chloride, potassium chloride, sodium bromide, potassium bromide, sodium iodide, potassium iodide, tetramethylammonium iodide, tetrabutylammonium iodide, tetraethylammonium iodide, tetrapropylammonium iodide, tetramethylammonium bromide, tetraethylammonium bromide, tetrapropylammonium bromide, tetrabutylammonium bromide, tetramethylammonium chloride, tetraethylammonium chloride, tetrapropylammonium chloride, tetrabutylammonium chloride, I₂, Cl₂, Br₂, or combinations thereof.

Additional configurations of the sorbent polymer composite material described herein and additional examples of the halogen sources described herein are set out in U.S. Pat. No. 9,827,551 to Hardwick et al and U.S. Pat. No. 7,442,352 to Lu et al, each of which are incorporated by reference herein in their entireties.

Some embodiments of the present disclosure are referred to as a “flow by” or “cross-flow” system because a reactant (such as the at least one gaseous component) is flowed by, over, across, or along a surface of a device that includes a sorbent polymer composite material. This is in contrast to “flow through” or “dead end” systems, in which reactants are flowed through a sorbent polymer composite material. In some embodiments, the sorbent polymer composite material is in the form of at least one sheet. In some embodiments, the at least one sheet includes a first surface and a second surface opposite the first surface. In some embodiments, the first surface is configured such that, when a flue gas stream having at least one gaseous component is flowed over (and by) the first surface of the at least one sheet, the at least one gaseous component reacts within the sorbent polymer composite material of the at least one sheet to form at least one liquid product. In some embodiments, the at least one gaseous component is flowed over (and by) both the first surface and the second surface of the at least one sheet.

In some embodiments, the at least one gaseous component includes at least one of: mercury vapor, at least one SOₓ compound, hydrogen sulfide, or combinations thereof. In some embodiments, the at least one liquid product includes at least one of: sulfuric acid liquid elemental sulfur, or combinations thereof. With respect to the at least one SOₓ compound, SOₓ removal can be a complex process requiring adequate SOₓ, O₂, and H₂O transport to create H₂SO₄ (sulfuric acid) by oxidation. To overcome the effect of sulfuric acid accumulation due to SOₓ oxidation, a sorbent polymer composite material can act as a “reverse sponge,” expelling the sulfuric acid.

Certain devices formed out of a sorbent polymer composite material can face significant challenges due to liquid accumulation. Performance can decline over time as the liquid forms a percolated network within the sorbent polymer composite material. Eventually, this network can become continuous with a surface of the sorbent polymer composite material and further liquid generation forces liquid to be expelled out to the surface of the sorbent polymer composite material. Owing to the low solubility and diffusivity of pollutants, the liquid wetted surface fraction of the sorbent polymer composite material can have a lower performance than the regions which remain dry. Thus, in some embodiments, the sorbent material of the sorbent polymer composite material removes a maximum possible amount of a target pollutant.

In some embodiments, the device comprises a plurality of sheets, which form a plurality of channels. In some embodiments, the plurality of sheets is configured such that the at least one liquid product is drainable through each channel of the plurality of channels. In some embodiments, the plurality of channels includes a plurality of adjacent channels, wherein each adjacent channel of the plurality of adjacent channels is connected.

In some embodiments, the article or device can be configured to provide highly efficient mercury capture with lower pressure drops than can be obtained through packed, granular beds of the sorbent material of the sorbent polymer composite material. Namely, the plurality of channels of the device can facilitate the flow of reactants, such as gaseous components, over one or more surfaces of the at least one sheet and facilitate the drainage of at least one liquid product. In some embodiments, the device includes a plurality of pleated sheets and a plurality of flat sheets in an alternating configuration.

### EXAMPLES AND COMPARATIVE DATA

The tables below show a comparative property detected and measured from an exemplary embodiment.

TABLE 1A

| | Span | Dry dP | Transport |
|---|---|---|---|
| Geometry | (mm) | (INWG) | Ratio |
| Example 1 | 12 | 0.13 | 1.54 |
| Example 2 | 7*2 | 0.13 | 1.33 |
| Example 3 | 7 | 0.32 | 1.68 |
| Comparative | 10 | 0.2 | 1 |
| Example (Triangle) | | | |
| Comparative | 6 | 0.09 | 0.68 |
| Example (Parallel | | | |
| Plates) | | | |

TABLE 1B

| | FOM (Transport | Weight | Transport/Weight |
|---|---|---|---|
| Geometry | Ratio/dP) | Ratio | Ratio |
| Example 1 | 2.32 | 0.85 | 1.8 |
| Example 2 | 2.04 | 0.8 | 1.65 |
| Example 3 | 1.05 | 1.38 | 1.22 |
| Comparative | 1 | 1 | 1 |
| Example (Triangle) | | | |
| Comparative | 1.55 | 0.55 | 1.24 |
| Example (Parallel | | | |
| Plates) | | | |

To evaluate and compare performances of Examples and Geometric forms, a series of computational fluid dynamic experiments was performed using the SOLIDWORKS Flow Simulation Suite (Dessault Systemes, Waltham, Massachusetts, USA). All simulations were run at a velocity of 3.6 m/s, with air at 60 degrees Celsius.

An equilateral triangular channel of 10 mm height was considered as the basis for comparison. All calculations were also compared to a common geometry of flow between parallel plates.

Span refers to the characteristic dimension between the center plane of the adjacent geometries forming channels, here measured in millimeters (mm). In the case of when the geometries with the previously described undulations form channels in multiple directions, a periodic boundary condition was used.

Pressure drop (dP) is defined as the difference in fluid pressure between the fluid inlet and outlet and is measured in inches of water column. Transport Ratio refers to the calculated heat transfer coefficient of the geometries, relative to the triangular channel performance (e.g., Example 3 transfers 68% more heat). Due to the Colburn-Chilton relation, this transport ratio is directly applicable to mass transfer operations such as a reaction-advection system.

The FOM (“Figure of Merit”) parameter divides the Transport Ratio by the pressure drop, giving a kind of “transport efficiency” where the energy used in fluid movement is a strong consideration.

Weight Ratio refers to the amount of material per unit volume a geometry contains. The Transport per Weight Ratio (Transport/Weight Ratio) refers to the Transport Ratio per unit material, which may be of interest in cases where the material is highly valuable. Because the area density is constant, this also is a metric for Transport per surface area.

The geometry for Example 1, which is according to an embodiment, has a sinusoidal shape. The out-of-plane amplitude in both directions is 6 mm (for a total geometry height of 12 mm). and the wavelength is 50 mm in the first (flow) direction and 20 mm in the second (perpendicular to flow) direction. This undulated geometry is connected to a flat sheet in between repeating undulated geometries as illustrated in sheets 300 in FIG. 3.

The geometry for Example 2, which is according to an embodiment, has a sinusoidal shape. The out-of-plane amplitude in both directions is 3.5 mm (for a total geometry height of 7 mm) and the wavelength is 50 mm in the first (flow) direction and 20 mm in the second (perpendicular to flow) direction. This undulated geometry is connected to a similar undulated geometry as illustrated in sheets 200 in FIG. 3. Peaks of the undulated sheets were aligned to one another.

The geometry for Example 3, which is according to an embodiment, has a sinusoidal shape. The out-of-plane amplitude in both directions is 3.5 mm (for a total geometry height of 7 mm). and the wavelength is 50 mm in the first (flow) direction and 20 mm in the second (perpendicular to flow) direction. This undulated geometry is connected to a flat sheet in between repeating undulated geometries as illustrated in sheets 300 in FIG. 3.

As can be seen from TABLES 1A-1B above, the three Examples show enhanced performance compared to the comparative examples. The transport ratio is 33% to 68% higher than the triangular channel shape and the FOM parameter is more than 100% larger even while using less material.

TABLE 2A

| | Dry SPC | | |
|---|---|---|---|
| | Weight | Wet dP | SO2 Removal |
| Geometry Stack | [g] | [INWG] | Efficiency |
| Example 4 | 139 | 0.94 | 12% |
| Example 5 | 198 | 1.09 | 10% |
| Example 6 | 106 | 0.79 | 9% |
| Comparative | 198 | 0.93 | 10% |
| Example (Triangle) | | | |
| Comparative | 137 | 0.78 | 8% |
| Example (Parallel | | | |
| Plates) | | | |

TABLE 2B

| | Hg | | |
|---|---|---|---|
| | Removal | Normalized | |
| | Efficiency | SO₂ RE/ | Normalized Hg |
| Geometry Stack | (RE) | Weight | RE/Weight |
| Example 4 | 34% | 1.64 | 2.09 |
| Example 5 | 31% | 0.99 | 1.34 |
| Example 6 | 14% | 1.61 | 1.12 |
| Comparative | 23% | 1 | 1 |
| Example (Triangular | | | |
| Channel, 10 mm) | | | |
| Comparative | | | |
| Example (Parallel | 18% | 1.1 | 1.1 |
| Plate Channel, 6 | | | |
| mm) | | | |

To confirm the observed simulation results, experiments were performed for mercury and SO₂ removal efficiency using standard sorbent polymer composite (SPC) materials. Here, the sorbent polymer composite (SPC) was created under laboratory conditions comprising 65.5% activated carbon (Norit PAC20BF, Cabot Inc., TX, USA), 20% PTFE, 9% Tetrabutylammonium iodide, and 5.5% sulfur was prepared using the general dry blending methodology taught in U.S. Pat. No. 7,791,861 to form composite samples. These SPC materials were then formed into geometries according to the current invention as follows.

A triangular channel was created by pleating the SPC sheets using a blade pleater and oriented next to a flat sheet to form a triangular channel of 10 mm height. A parallel plate geometry was created by placing two flat SPC sheets next to each other and using a plurality of Polypropylene posts and neoprene o-rings (commercially available from McMaster-Carr, Elmhurst, Illinois, USA) as spacers to form a 6 mm parallel plate channel.

The geometry of the SPC sheets for Example 4, which is according to an embodiment, has a sinusoidal shape. The out-of-plane amplitude in both directions is 3.5 mm (for a total geometry height of 7 mm) and the wavelength is 50 mm in the first (flow) direction and 20 mm in the second (perpendicular to flow) direction. This undulated SPC sheet is connected to 10 mm equilaterally triangle pleated SPC sheets as described above to form a layered geometry of undulated and pleated SPC sheets.

The geometry of the SPC sheets for Example 5, which is according to an embodiment, has a sinusoidal shape. The out-of-plane amplitude in both directions is 3.5 mm (for a total geometry height of 7 mm) and the wavelength is 50 mm in the first (flow) direction and 20 mm in the second (perpendicular to flow) direction. This undulated SPC sheet is connected to a similar undulated SPC sheets as illustrated in sheets 200 in FIG. 3.

The geometry of the SPC sheets for Example 6, which is according to an embodiment, has a sinusoidal shape. The out-of-plane amplitude in both directions is 6.2 mm (for a total geometry height of 12.4 mm). and the wavelength is 100 mm in the first (flow) direction and 12.7 mm in the second (perpendicular to flow) direction. This undulated SPC sheet is connected to a flat SPC sheet in between repeating undulated geometries as illustrated in sheets 300 in FIG. 3.

Removal efficiency tests for Hg and SO₂ removal were performed using an apparatus including: (1) a supply of air regulated by an air blower. The humidity level of the air stream was controlled by flowing through a humidification system including a gas pre-heater and a heated humidification chamber; (2) A mercury supply generated by flowing a small nitrogen purge through a vessel of liquid mercury that was placed in a temperature controlled bead bath; (3) A SO₂ supply from an SO₂ generation system. SO₂ was generated by mixing concentrated sulfuric acid with a solution of sodium metabisulfite that is transported by a small nitrogen purge; (4) A gas mixing zone where the gas streams the humidified air is mixed with the mercury and SO₂ supply streams; (5) a sample cell fitted with gas sampling ports before and after the sample, and located in an oven; (6) A mercury analyzer that measures the total mercury (the gas sampling line was flown through a stannous chloride/HCl bubbler to convert any oxidized mercury to elemental mercury before the analyzer); and (7) an SO₂ detection analyzer.

Efficiency is reported as the difference between inlet mercury levels (bypassing the sample) and outlet levels (passing through the sample). Percent efficiency is defined as follows:

% Efficiency=100×[Concentration₍ᵢₙₗₑₜ₎−Concentration₍ₒᵤₜₗₑₜ₎]/[Concentration₍ᵢₙₗₑₜ₎]

The sample cell was comprised of a horizontal duct measuring 50 mm×50 mm×300 mm. Horizontal here refers to the direction of airflow being orthogonal to the vector of gravity, allowing drainage of the created sulfuric acid phase to factor into overall performance. The face velocity was 3.6 m/s, with an inlet SO₂ concentration of 100 ppm, with the balance fully saturated humid air. Mercury inlet concentration was approximately 15 μg/m³ in elemental form.

The results of the removal efficiency testing are summarized in TABLES 2A-2B. Dry SPC Weight refers to the amount of material contained in the duct. Wet dP refers to the fact that, in contrast to the CFD results, an additional liquid phase is formed clinging to the SPC material, which is affecting airflow.

Both SO₂ and Hg were added to evaluate performance. Elemental Hg has limited solubility, and is highly affected by a liquid phase blinding access to reactive materials. In contrast, SO₂ is highly soluble in the liquid acid phase, and is less affected by the presence of liquid. All three Examples with geometries show improved removal efficiency performance relative to the two comparative geometries tested.

### ASPECTS

Various Aspects are described below. It is to be understood that any one or more of the features recited in the following Aspect(s) can be combined with any one or more other Aspect(s).

Aspect 1. An article comprising:
a first sheet,
wherein the first sheet having a surface topology,
wherein the surface topology comprises a first set of at least three critical portions,
wherein each of the at least three critical portions is:
(a) a minimum,
(b) a saddle, or
(c) a maximum.

Aspect 2. The article according to Aspect 1
wherein the surface topology includes channels along a first direction,
wherein the channels are configured to direct fluid flow substantially along a first direction.

Aspect 3. The article of Aspect 2, wherein the first sheet comprises:
a filter material;
a heat exchange surface;
an active material;
a reactive material; or
a combination thereof.

Aspect 4. The article of Aspect 3, wherein the surface topology is substantially uniform along the first direction.

Aspect 5. The article of Aspect 3, wherein the channels are configured such that the fluid flow is substantially uniform flow.

Aspect 6. The article of Aspect 4, wherein the minimum, the saddle, and the maximum are along a second direction, wherein the second direction is different from the first direction.

Aspect 7. The article of Aspect 6, wherein the surface topology is configured such that the fluid flow along the second direction is substantially non-uniform flow.

Aspect 8. The article of Aspect 1, wherein at least one of the each of the three critical portions is a critical point.

Aspect 9. The article of any of Aspects 1-8, wherein the surface topology further comprises straight edges connecting at least two of the at least three critical portions.

Aspect 10. The article of any of Aspects 1-9, wherein the surface topology further comprises curved portions connecting at least two of the at least three critical portions.

Aspect 11. The article of any of Aspects 1-10, wherein the surface topology comprises a geometric wave cross section.

Aspect 12. The article of Aspect 11, wherein the geometric wave cross section comprises:
a sinusoidal wave cross section;
a non-sinusoidal periodic wave cross section;
a triangular wave cross section;
a rectangular wave cross section;
a square wave cross section; or
a combination thereof.

Aspect 13. The article of any of Aspects 3-12, wherein the filter material comprises a sorbent polymer composite material.

Aspect 14. The article of Aspect 13, wherein the sorbent polymer composite material comprises:
a sorbent material; and
a polymer material.

Aspect 15. The article of Aspect 14, wherein the sorbent material comprises at least one of an activated carbon, a silica gel, a zeolite, or a combination thereof.

Aspect 16. The article of any of Aspects 14-15, wherein the polymer material comprises at least one of polytetrafluoroethylene; polyfluoroethylene propylene; polyperfluoroacrylate; polyvinyllidene fluoride; a terpolymer of tetrafluoroethylene; hexafluoropropylene-vinylidene-fluoride, polychlorotrifluoroethylene, or a combination thereof.

Aspect 17. The article of any of Aspects 1-16, further comprising a second sheet connected to the first sheet.

Aspect 18. The article of Aspect 17, wherein the second sheet has a second surface topology comprising a flat portion.

Aspect 19. The article of Aspect 17, wherein the second sheet has a second surface topology,

wherein the second surface topology comprises a second set of at least three critical portions,
wherein each of the at least three critical portions is:
(a) a second minimum,
(b) a second saddle, or
(c) a second maximum.

Aspect 20. The article of Aspect 19, wherein the second sheet includes a second filter material.

Aspect 21. The article of Aspect 20, wherein at least one of the at least three critical portions of the first sheet is coupled to the second sheet.

Aspect 22. The article of Aspect 21, where in the first sheet is coupled to the second sheet by an adhesive, an ultrasonic weld, or a combination thereof.

Aspect 23. The article of Aspect 21, where in the first sheet is coupled to the second sheet by an adhesive.

Aspect 24. The article of any of Aspects 17-23, further comprising a module frame,
wherein the first sheet and the second sheet are connected to the module frame.

Aspect 25. A module, comprising:
a plurality of sheets,
wherein each of the plurality of sheets has a surface topology comprising at least three critical portions, wherein each of the at least three critical portions is:
(a) a minimum,
(b) a saddle, or
(c) a maximum.

Aspect 26. The module of Aspect 25, wherein each of the plurality of sheets comprises a filter material.

Aspect 27. The module of Aspect 26, wherein the filter material comprises a sorbent polymer composite material.

Aspect 28. The module of Aspect 27, wherein the sorbent polymer composite material comprises:
a sorbent material; and
a polymer material.

Aspect 29. A method of producing the article of any of Aspects 1-28, comprising:
obtaining a sheet;
rolling the sheet over a roller having a roller mold; and
forming a surface topology on the sheet,
wherein the surface topology comprises at least three critical portions, wherein
each of the at least three critical portions is:
(a) a minimum,
(b) a saddle, or
(c) a maximum.

Aspect 30. The method of Aspect 29, wherein the sheet comprises:
a filter material;
a heat exchange surface;
an active material;
a reactive material; or
a combination thereof.

Aspect 31. The method of any of Aspects 29-30, further comprising:
obtaining a second sheet;
rolling the second sheet over the roller having the roller mold; and
forming a second surface topology on the second sheet,
wherein the second surface topology comprises at least three critical portions,
wherein each of the at least three critical portions is:
(a) a second minimum,
(b) a second saddle, or
(c) a second maximum; and
bonding together at least a portion of the sheet and at least a portion of the second sheet.

Aspect 32. The method of Aspect 31, wherein the portion of the sheet includes one of the at least three critical portions of the sheet.

Aspect 33. The method of Aspect 32, wherein the portion of the second sheet includes one of the at least three critical portions of the second sheet.

Aspect 34. The method of Aspect 31, wherein the portion of the second sheet includes one of the at least three critical portions of the second sheet.

All prior patents and publications referenced herein are incorporated by reference in their entireties.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components. As used herein, the term “based on” is not exclusive and allows for being based on additional factors not described, unless the context clearly dictates otherwise. In addition, the meaning of “in” includes “in” and “on.”

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1.-34. (canceled)

35. An article comprising:
a first sheet,
wherein the first sheet having a surface topology,
wherein the surface topology comprises a first set of at least three critical portions,
wherein each of the at least three critical portions is one of:
(a) a minimum,
(b) a saddle, or
(c) a maximum.

36. The article according to claim 35,
wherein the surface topology includes flow channels along a first direction,
wherein the channels are configured to direct fluid flow substantially along the first direction, and
wherein, optionally, the minimum, the saddle, and the maximum are along a second direction, wherein the second direction is different from the first direction.

37. The article of claim 35, wherein the first sheet comprises:
a filter material;
a heat exchange surface;
an active material;
a reactive material; or
a combination thereof.

38. The article of claim 35, wherein the surface topology is substantially linear along the first direction, or,
wherein the channels are configured such that the fluid flow is substantially uniform flow.

39. The article of claim 35, wherein the surface topology is configured such that the fluid flow along the second direction is substantially non-uniform flow.

40. The article of claim 35, wherein at least one of the each of the three critical portions is a critical point.

41. The article of claim 35, wherein the surface topology further comprises straight edges connecting at least two of the at least three critical portions, or,
wherein the surface topology further comprises curved portions connecting at least two of the at least three critical portions, or,
wherein the surface topology comprises a geometric wave cross section,
wherein, optionally, the geometric wave cross section comprises:
a sinusoidal wave cross section;
a non-sinusoidal periodic wave cross section;
a triangular wave cross section;
a rectangular wave cross section;
a square wave cross section; or
a combination thereof.

42. The article of claim 7, wherein the filter material comprises a sorbent polymer composite material comprising:
a sorbent material; and
a polymer material.

43. The article of claim 13, wherein the sorbent material comprises at least one of an activated carbon, a silica gel, a zeolite, or a combination thereof.

44. The article of claim 13, wherein the polymer material comprises at least one of polytetrafluoroethylene; polyfluoroethylene propylene; polyperfluoroacrylate; polyvinyllidene fluoride; a terpolymer of tetrafluoroethylene; hexafluoropropylene-vinylidene-fluoride, polychlorotrifluoroethylene, or a combination thereof.

45. The article of claim 35, further comprising a second sheet connected to the first sheet,
wherein, optionally, the second sheet has a second surface topology comprising a flat portion.

46. The article of claim 45, wherein the second sheet has a second surface topology,
wherein the second surface topology comprises a second set of at least three critical portions,
wherein each of the at least three critical portions is:
(a) a second minimum,
(b) a second saddle, or
(c) a second maximum,
optionally
the second sheet includes a second filter material;
a heat exchange surface;
an active material;
a reactive material; or
a combination thereof.

47. The article of claim 46, wherein at least one of the at least three critical portions of the first sheet is coupled to the second sheet.

48. The article of claim 47, where in the first sheet is coupled to the second sheet by an adhesive, an ultrasonic weld, or a combination thereof.

49. The article of claim 47, where in the first sheet is coupled to the second sheet by an adhesive.

50. The article of claim 45, further comprising a module frame, wherein the first sheet and the second sheet are connected to the module frame.

51. A module, comprising:
a plurality of sheets,
wherein each of the plurality of sheets has a surface topology comprising at least three critical portions, wherein each of the at least three critical portions is:
(a) a minimum,
(b) a saddle, or
(c) a maximum.

52. The module of claim 51, wherein each of the plurality of sheets comprises a filter material, optionally comprising a sorbent polymer composite material comprising a sorbent material; and
a polymer material; a heat exchange surface;
an active material;
a reactive material; or
a combination thereof.

53. A method of producing the article of claim 1, comprising:
obtaining a sheet, optionally comprising:
a filter material;
a heat exchange surface;
an active material;
a reactive material; or
a combination thereof;
rolling the sheet over a roller having a roller mold; and
forming a surface topology on the sheet,
wherein the surface topology comprises at least three critical portions,
wherein each of the at least three critical portions is:
(a) a minimum,
(b) a saddle, or
(c) a maximum.

54. The method of claim 53, further comprising:
obtaining a second sheet;
rolling the second sheet over the roller having the roller mold; and
forming a second surface topology on the second sheet,
wherein the second surface topology comprises at least three critical portions, wherein each of the at least three critical portions is:
(a) a second minimum,
(b) a second saddle, or
(c) a second maximum; and
bonding together at least a portion of the sheet and at least a portion of the second sheet, and wherein the portion of the sheet includes one of the at least three critical portions of the sheet, or,
wherein the portion of the second sheet includes one of the at least three critical portions of the second sheet, or,
wherein the portion of the second sheet includes one of the at least three critical portions of the second sheet.
